(19) United States
(12) Patent Application Publication
(10) Pub. No.: US 2025/0354386 A1
(43) Pub. Date: Nov. 20, 2025

(54) INSULATION HATCH WITH A SPACER AND ATTIC STAIRS WITH THE INSULATION HATCH

(71) Applicant: FAKRO PP SP. z o. o., Nowy Sacz (PL)

(72) Inventors: Jaroslaw WITOWSKI, Nowy Sacz (PL); Boguslaw KASINSKI, Limanowa (PL)

(73) Assignee: FAKRO PP SP. z o. o., Nowy Sacz (PL)

(21) Appl. No.: 19/210,472

(22) Filed: May 16, 2025

(30) Foreign Application Priority Data
May 17, 2024 (PL) P.448588

(51) Int. Cl. E04F 11/06

(52) U.S. Cl. CPC E04F 11/062; E04F 2290/04

(57) ABSTRACT

Insulation hatch for attic stairs constructed out of rigid layer (12), protective layer (11) and insulation layer (13) wherein insulation layer (13) is located between rigid layer (12) and protective layer (11) and insulation hatch layers are connected to each other and in protective layer (11) and in insulation layer (13) there is at least one spacer (4) for taking on the load exerted on the insulation hatch, in particular during transport, and the subject-matter of the invention also comprises attic stairs with the said insulation hatch.

The subject-matter of the invention is an insulation hatch with a spacer and attic stairs with the said insulation hatch.

Attic stairs with an insulation hatch comprising two rigid layers and a layer of insulating material between them has been disclosed under DE2830317A1. The layers are connected to each other using a bolt, in such a way that it is inserted from the side of the rigid outer layer towards the rigid inner layer so that it passes through a part of the hinge connecting the box with the attic stairs insulation hatch.

In a transport position, attic stairs are stacked one on top of another and exert pressure on themselves. For attic stairs with an insulation hatch, i.e. with a hatch which is in most part composed of a light material, with low compressive strength, the said pressure may cause the insulation hatch to deform. In the disclosed solution, the layered insulation hatch comprises a core made out of a layer of low compressive strength material, however in the disclosed solution the problem associated with that material deforming during transport when attic stairs are stacked on top of each other has not been addressed. The bolt connecting insulation hatch layers also attaches the attic stairs hinge connecting the insulation hatch with the box.

The subject-matter of the invention comprises an insulation hatch for attic stairs with a spacer according to claim 1, where the said spacer takes on the load exerted on the insulation hatch, preventing the insulation hatch from deforming in particular whilst transporting attic stairs.

The insulation hatch for attic stairs comprising a rigid layer, a protective layer and an insulation layer wherein the insulation layer is located between the rigid layer and the protective layer. Preferably the insulation hatch rigid and protective layers are made out of the same material, and there is at least one reinforcement slat between the rigid layers, in particular seated along an insulation layer edge. Preferably the insulation layer is made out of expanded polystyrene, stone wool, or polyurethane foam. The insulation hatch layers are connected to each other preferably using a bolt. In the protective layer and in the insulation layer there is at least one spacer to take on the load exerted on the insulation hatch. The spacer also comprising a through hole for a connecting means, connecting the insulation hatch layers to each other, and in particular for a bolt. At the end, the through hole diameter is smaller, so that the bolt has to be lightly hammered into the hole, and the bolt will not fall out of the through hole by itself when the panel is positioned with the rigid layer facing down. The structure of the spacer allows it to perform additional functions, such as they constitute a place where additional elements may be installed to the insulation hatch. To that end, the spacer comprising a seating means for fixing additional elements on the insulation hatch, such as a socket limited by spacer flange walls and/or a socket for positioning additional installation means on the spacer. Once the spacer is placed in the insulation layer, its circumference flange is flush with the insulation hatch protective layer. The insulation hatch is used for attic stairs comprising a box, a foldable ladder designed to be installed on the insulation hatch, a fittings unit for suspending the insulation hatch in the stairs box and at least one installation means for installing the foldable ladder on the insulation hatch, wherein the installation means is located on the insulation hatch spacer. The installation means comprises an angle bracket for attaching attic stairs ladder to the insulation hatch. The angle bracket features two arms at an angle to one another, so that one of the arms is seated in the socket limited by the spacer flange. Additionally, the angle bracket features a positioning ridge designed to be inserted into the spacer positioning socket. The seating means prevents uncontrolled rotation of the angle bracket attached to the insulation hatch. The foldable ladder is attached to the first arm of the angle bracket using a flat bar which is a part of the fittings unit.

The solution is depicted on the drawing below with given figures showing the following:

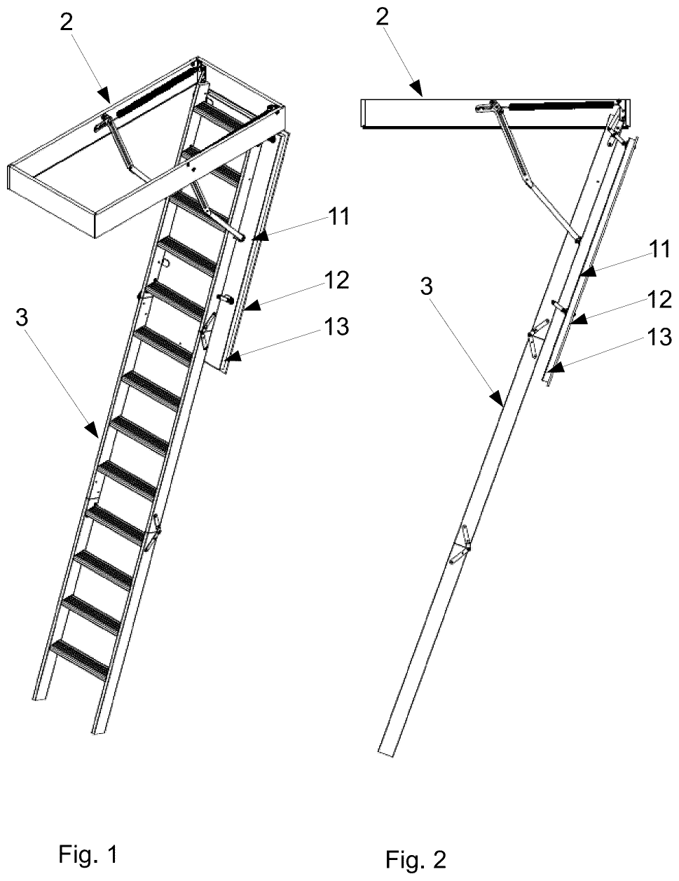

FIG. 1 spatial view of attic stairs

FIG. 2 side view of attic stairs

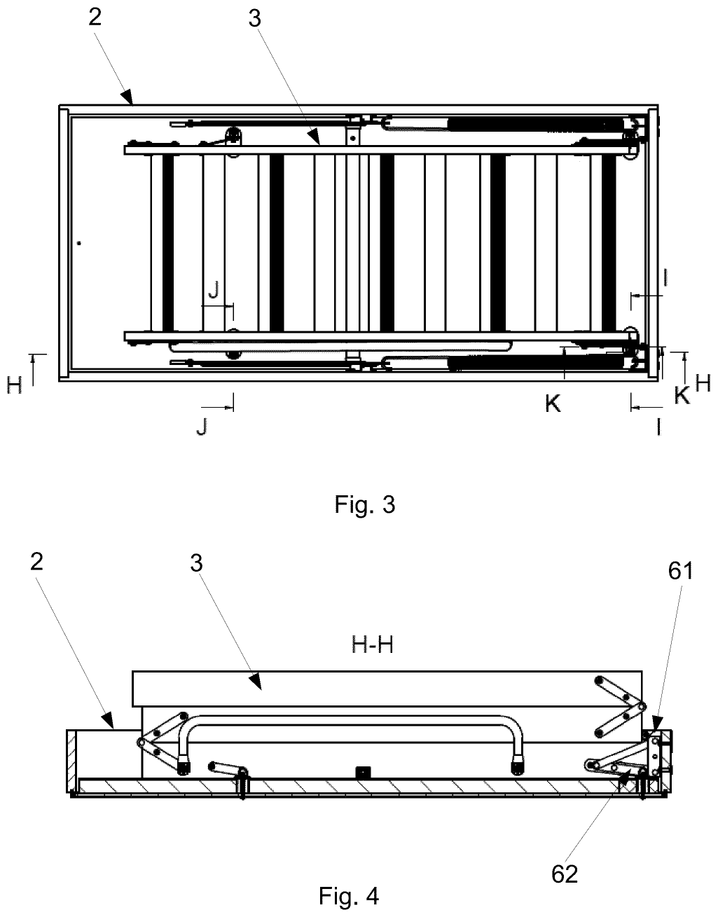

FIG. 3 top view of retracted attic stairs

FIG. 4 side view of retracted attic stairs

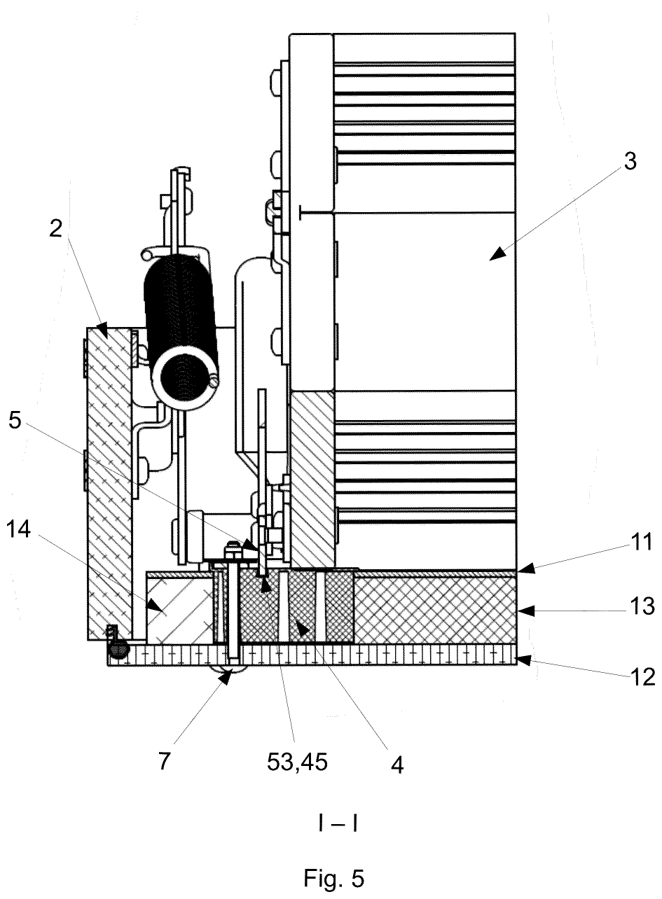

FIG. 5 I-I cross section of attic stairs shown in FIG. 3

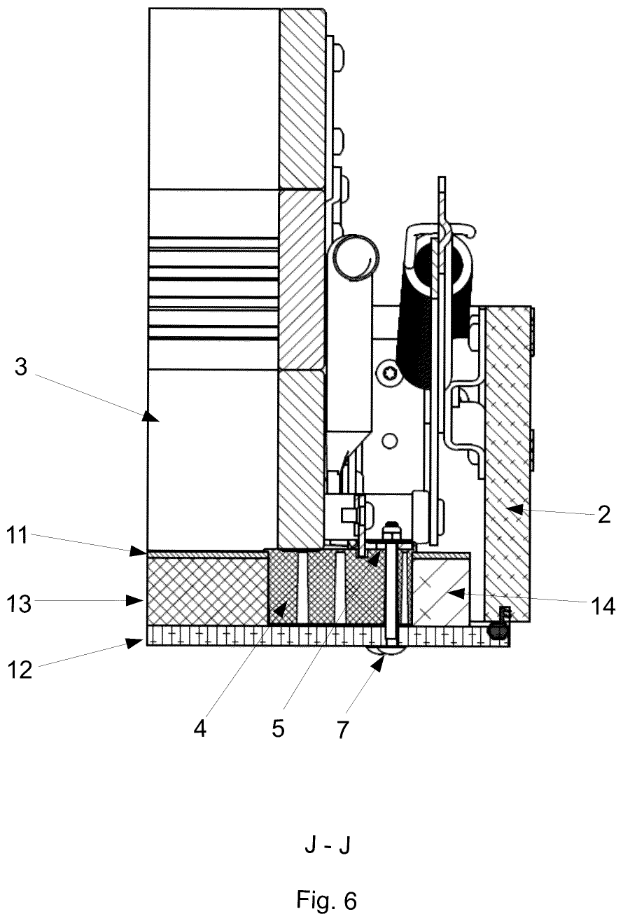

FIG. 6 J-J cross section of attic stairs shown in FIG. 3

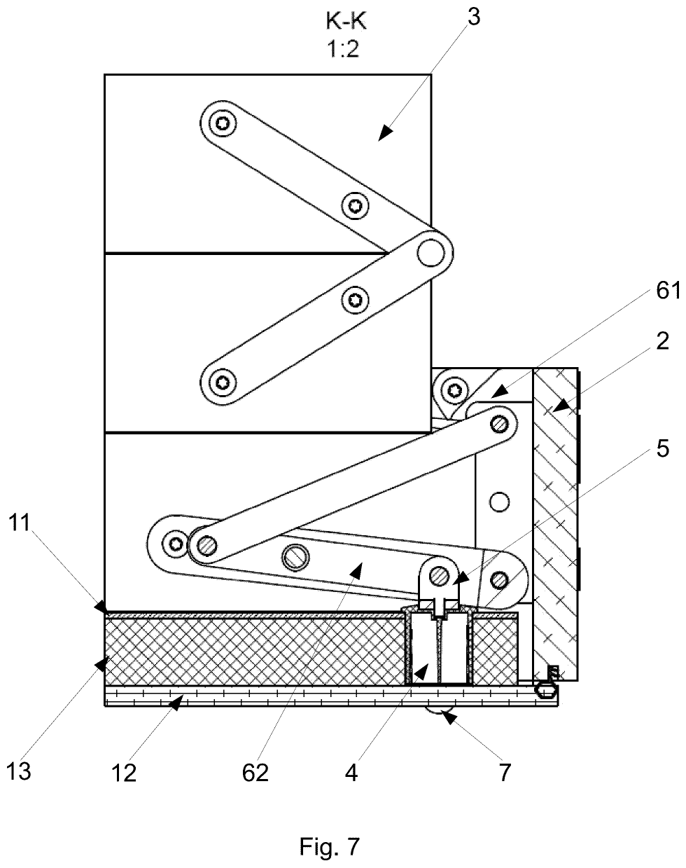

FIG. 7 K-K cross section of attic stairs shown if FIG. 3

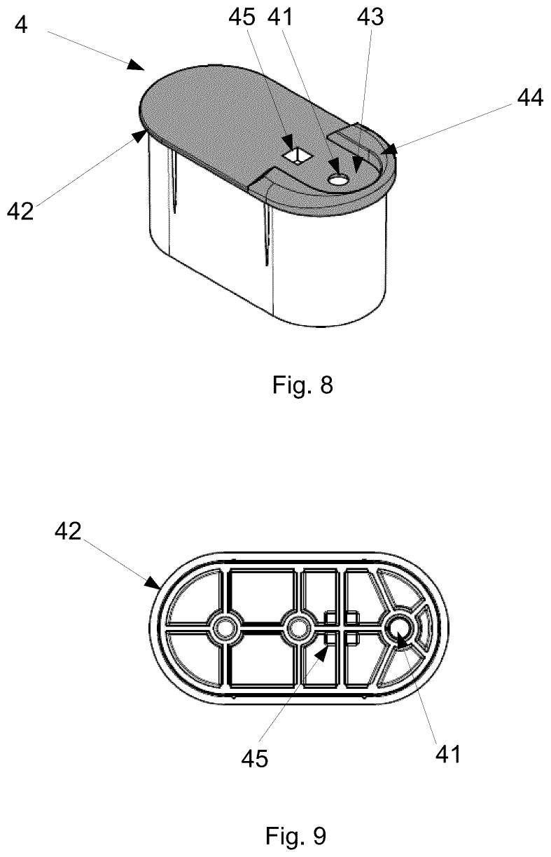

FIG. 8 spatial view of spacer

FIG. 9 bottom view of spacer

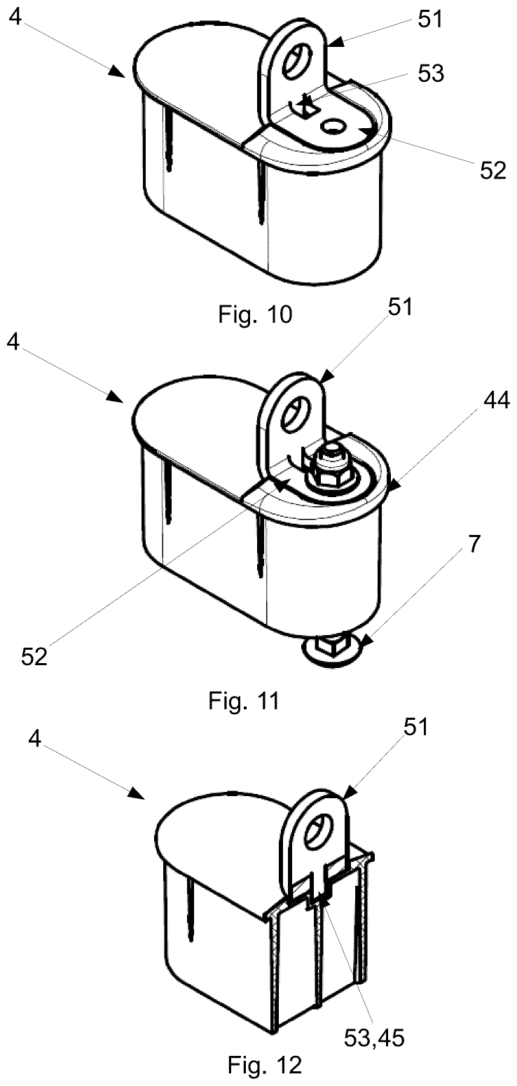

FIG. 10 spacer with additional installation means in the form of an angle bracket

FIG. 11 spacer with additional installation means in the form of an angle bracket with a bolt

FIG. 12 cross section of the spacer with additional installation means in the form of an angle bracket

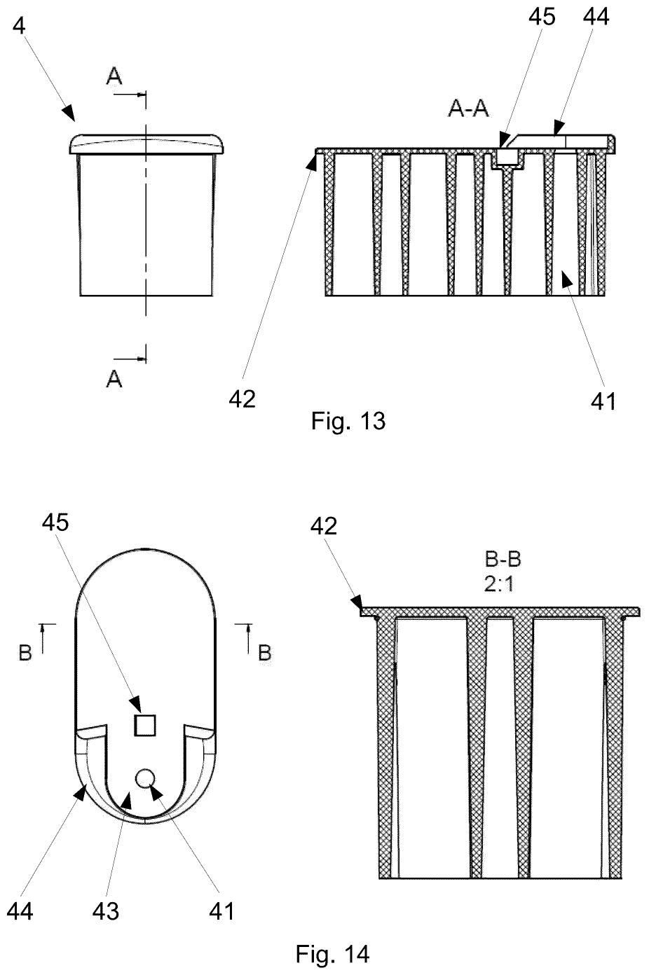

FIG. 13 front view of spacer with its A-A cross section

FIG. 14 top view of spacer with its B-B cross section

The insulation hatch according to the invention comprising a protective layer 11, a rigid layer 12 and an insulation layer 13, wherein the insulation layer 13 is located between the protective and the rigid layers. Between rigid layer 12 and the protective layer 11 at the expense of insulation layer 13 volume there are reinforcement slats 14 to stiffen the insulation hatch structure. After installing the insulation hatch in attic stairs box 2, its rigid layer 12 is located on the outside of the attic stairs and foldable ladder 3 is located on protective layer 11. Foldable ladder 3 is attached to spacer 4 and is suspended in box 2 using a fittings unit hinge 61. Insulation hatch layers are connected to each other using a connecting means, preferably a bolt 7, inserted from the side of rigid layer 12 into insulation hatch spacer 4, and for that purpose spacer 4 features a through hole 41. In order to prevent connecting the bolt 7 from falling out of the through hole 41, its diameter is reduced at one end, i.e. in the proximity of insulation hatch protective layer 11. The spacer 4 is inserted from the side of protective layer 11 into insulation layer 13, so that the spacer 4 circumference flange 42 is resting on the protective layer 11 around the opening prepared for spacer 4. The spacer 4 features a seating means for fixing additional elements on the insulation hatch, which constitute attic stairs elements. The seating means constitutes socket 43 limited by a spacer flange 44 walls and positioning a socket 45 for additional installation means on the spacer. An angle bracket 5 constitutes an additional installation means for attaching attic stairs foldable ladder 3 to the insulation hatch. The angle bracket 5 features two arms 51 and 52, which are at an angle to one another so that one of the arms, referred to as second arm 52, is seated in socket 43 limited by spacer flange 44. The angle bracket first arm 51 features a positioning ridge 53 for placing in spacer positioning socket 45 and angle bracket first arm 51 constitutes the connection point between the angle bracket 5 and a fittings unit flat bar 62 which connects the foldable ladder 3 to the insulation hatch.

1. An insulation hatch for attic stairs comprising a rigid layer, a protective layer, and an insulation layer, so that the insulation layer is located between the rigid layer and the protective layer and the insulation hatch layers are connected with each other, characterized in that in the protective layer and the insulation layer there is at least one spacer for taking on the load exerted on the insulation hatch in particular during transport.

2. The insulation hatch according to claim 1 characterized in that the spacer comprises a through hole for a connecting means, in particular a bolt connecting the insulation hatch layers to one another.

3. The insulation hatch according to claim 2 characterized in that the through hole features a reduced diameter at an end section, i.e. in the proximity of the protective layer.

4. The insulation hatch according to claim 1 characterized in that the spacer features a seating means for fixing additional elements to the insulation hatch.

5. The insulation hatch according to claim 4 characterized in that the seating means constitutes a socket limited by a spacer flange walls.

6. The insulation hatch according to claim 4 characterized in that the seating means constitutes a positioning socket for an additional installation means on the spacer.

7. The insulation hatch according to claim 1 characterized in that the insulation hatch rigid layer and protective layer are made out of the same material.

8. The insulation hatch according to claim 1 characterized in that the insulation hatch comprising a reinforcement slats between the rigid layer and the protective layer.

9. The insulation hatch according to claim 1 characterized in that the spacer comprises a circumference flange.

10. An attic stairs comprising a box and the insulation hatch according to claim 1, a foldable ladder designed for installation on the insulation hatch, a fittings unit for suspending the insulation hatch in the attic stairs box and at least one installation means for installation the foldable ladder on the insulation hatch, characterized in that the installation means is located on the insulation hatch spacer.

11. The attic stairs according to claim 10 characterized in that the installation means constitutes an angle bracket for attaching attic stairs foldable ladder to the insulation hatch.

12. The attic stairs according to claim 10 characterized in that the angle bracket features two arms at an angle relative to one another so that one of the arms, referred to as a second arm, is seated in a socket limited by a spacer flange.

13. The attic stairs according to claim 10 characterized in that the angle bracket first arm features a positioning ridge to be placed inside the spacer positioning socket.

14. The attic stairs according to claim 10 characterized in that the foldable ladder is attached to angle bracket first arm using a fittings unit, and in particular a flat bar.
